(19) United States
(12) Patent Application Publication
(10) Pub. No.: US 2016/0371004 A1
(43) Pub. Date: Dec. 22, 2016

(54) MEMORY SYSTEM AND OPERATING METHOD THEREOF

(71) Applicant: SK hynix Inc., Gyeonggi-do (KR)

(72) Inventor: Hae-Gi CHOI, Seoul (KR)

(21) Appl. No.: 14/939,736

(22) Filed: Nov. 12, 2015

(30) Foreign Application Priority Data
Jun. 17, 2015 (KR) 10-2015-0085759

(51) Int. Cl. G06F 3/06; G06F 12/12; G06F 12/08

(52) U.S. Cl. CPC G06F 3/0604; G06F 3/0608; G06F 3/0644; G06F 3/0685; G06F 12/0804; G06F 12/12; G06F 2212/69

(57) ABSTRACT

A memory system includes a memory device; a memory suitable for temporarily storing data transferred between a host and the memory device; and a controller suitable for classifying data provided from the host into first classification data of relatively great size based on a reference size and second classification data of relatively small size based on the reference size, classifying one or more of the second classification data, which is repeatedly provided more than a threshold value of repetition, as third classification data, and managing the third classification data only in the memory.

### CROSS-REFERENCE TO RELATED APPLICATION(S)

The present application claims priority of Korean Patent Application No. 10-2015-0085759, filed on Jun. 17, 2015, which is incorporated herein by reference in its entirety.

### BACKGROUND

1. Field

Exemplary embodiments of the present invention relate to a semiconductor design technology, and more particularly, to a data management configuration for a memory system and an operating method of the memory system.

2. Description of the Related Art

The computer environment paradigm has shifted to ubiquitous computing systems that can be used anytime and anywhere. As such, the use of portable electronic devices such as mobile phones, digital cameras, and notebook computers has rapidly increased. These portable electronic devices generally use a memory system having memory devices, that is, a data storage device. The data storage device is used as a main memory device or an auxiliary memory device of the portable electronic devices.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

### SUMMARY

Various embodiments are directed to a memory system capable of classifying and managing a type of data based on a size of data provided from a host and an operating method of the memory system.

In an embodiment, a memory system may include a memory device; a memory suitable for temporarily storing data transferred between a host and the memory device; and a controller suitable for classifying data provided from the host into first classification data of relatively great size based on a reference size and second classification data of relatively small size based on the reference size, classifying one or more of the second classification data, which is repeatedly provided more than a threshold value of repetition, as third classification data, and managing the third classification data only in the memory.

When the first classification data is repeatedly provided more than two times, the controller may classify the second classification data that is provided between the repeatedly provided first classification data and that repeatedly has a same logical address more than the threshold value of repetition as the third classification data.

The controller may be suitable for accumulating the logical addresses of the second classification data in a logical address storage space whenever the second classification data is provided; and classifying one or more of the second classification data having the accumulated number of the logical address greater than the threshold value of repetition as the third classification data.

The controller may be suitable for classifying a bulk of data having a size greater than a first reference size and random logical address, or a series of data, each of which has a size smaller than the first reference size and greater than a second reference size, and which have continuous logical addresses, as the first classification data.

The controller may be suitable for storing the first and the second classification data in the memory when a write operation is performed, writing the first and the second classification data of the memory into the memory device, and keeping the third classification data in the memory.

During a cache flush operation, the controller may delete the first and the second classification data from the memory while keeping the third classification data in the memory.

The first and the second classification data may include user data, and the third classification data may include metadata.

In an embodiment, an operating method of a memory system comprising a memory device and a memory may include classifying data provided from the host into first classification data of relatively great size based on a reference size and second classification data of relatively small size based on the reference size; classifying one or more of the second classification data, which is repeatedly provided more than a threshold value of repetition, as third classification data; and managing the third classification data only in the memory.

When the first classification data is repeatedly provided more than two times, the classifying the second classification data as the third classification data may include classifying the second classification data that is provided between the repeatedly provided first classification data and that repeatedly has a same logical address more than the threshold value of repetition as the third classification data.

The classifying the second classification data as the third classification data may include: accumulating the logical addresses of the second classification data in a logical address storage space whenever the second classification data is provided; and classifying one or more of the second classification data having the accumulated number of the logical address greater than the threshold value of repetition as the third classification data.

The classifying of the data into the first and second classification data may include classifying a bulk of data having a size greater than a first reference size and random logical address, or a series of data, each of which has a size smaller than the first reference size and greater than a second reference size, and which have continuous logical addresses, as the first classification data.

The managing of the third classification data may include: storing the first and the second classification data in the memory when a write operation is performed; writing the first and the second classification data of the memory into the memory device; and keeping the third classification data in the memory.

The managing of the third classification data may include deleting the first and the second classification data from the memory while keeping the third classification data in the memory during a cache flush operation.

The first and the second classification data may include user data, and the third classification data may include metadata.

### BRIEF DESCRIPTION OF THE DRAWINGS

FIG. 1 is a diagram illustrating a data processing system including a memory system in accordance with an embodiment.

FIG. 2 is a diagram illustrating a memory device in a memory system.

FIG. 3 is a circuit diagram illustrating a memory block in a memory device in accordance with an embodiment.

FIGS. 4, 5, 6, 7, 8, 9, 10 and 11 are diagrams schematically illustrating a memory device.

FIGS. 12A and 12B and FIGS. 13A and 13B are diagrams illustrating a method of classifying data provided from the host in the memory system in accordance with an embodiment of the present invention.

FIG. 14 is a flowchart illustrating the method of classifying data provided from the host in the memory system in accordance with an embodiment of the present invention.

FIG. 15 is a diagram illustrating a cache flush operation of the memory system in accordance with an embodiment of the present invention.

FIG. 16 is a flowchart illustrating the cache flush operation of the memory system in accordance with an embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

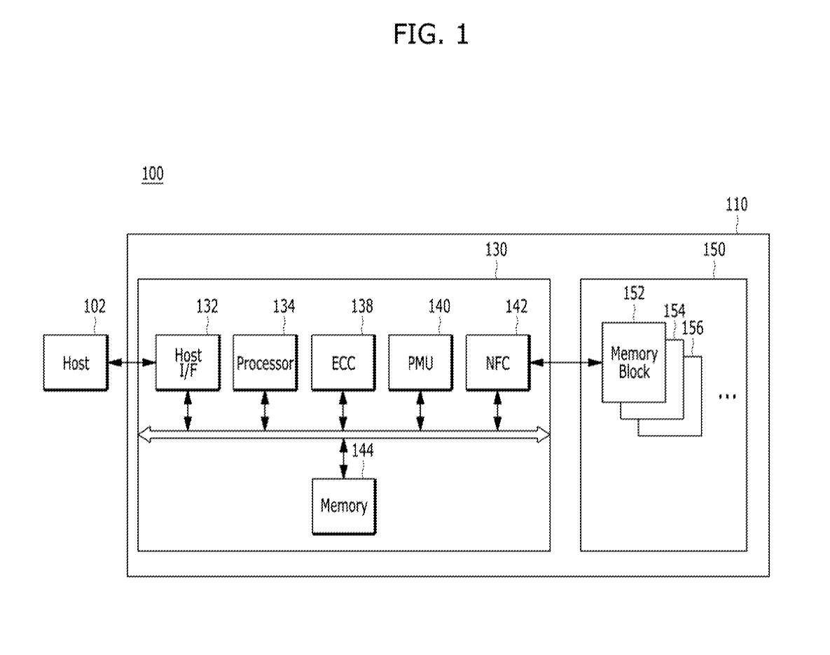

FIG. 1 is a block diagram illustrating a data processing system including a memory system in accordance with an embodiment.

Referring to FIG. 1, a data processing system 100 may include a host 102 and a memory system 110.

The host 102 may include, for example, a portable electronic device such as a mobile phone, an MP3 player and a laptop computer or an electronic device such as a desktop computer, a game player, a TV and a projector.

The memory system 110 may operate in response to a request from the host 102, and in particular, store data to be accessed by the host 102. In other words, the memory system 110 may be used as a main memory system or an auxiliary memory system of the host 102. The memory system 110 may be implemented with any one of various kinds of storage devices, according to the protocol of a host interface to be electrically coupled with the host 102. The memory system 110 may be implemented with various kinds of storage devices such as a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and so forth.

The storage devices for the memory system 110 may be implemented with a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM) and a resistive RAM (RRAM).

The memory system 110 may include a memory device 150 which stores data to be accessed by the host 102, and a controller 130 which may control storage of data in the memory device 150.

The controller 130 and the memory device 150 may be integrated into one semiconductor device. For instance, the controller 130 and the memory device 150 may be integrated into one semiconductor device and configure a solid state drive (SSD). When the memory system 110 is used as the SSD, the operation speed of the host 102 that is electrically coupled with the memory system 110 may be significantly increased.

The controller 130 and the memory device 150 may be integrated into one semiconductor device and configure a memory card. The controller 130 and the memory card 150 may be integrated into one semiconductor device and configure a memory card such as a Personal Computer Memory Card International Association (PCMCIA) card, a compact flash (CF) card, a smart media (SM) card (SMC), a memory stick, a multimedia card (MMC), an RS-MMC and a micro-MMC, a secure digital (SD) card, a mini-SD, a micro-SD and an SDHC, and a universal flash storage (UFS) device.

Furthermore, the memory system 110 may configure a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a three-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID device, and/or one of various component elements configuring a computing system.

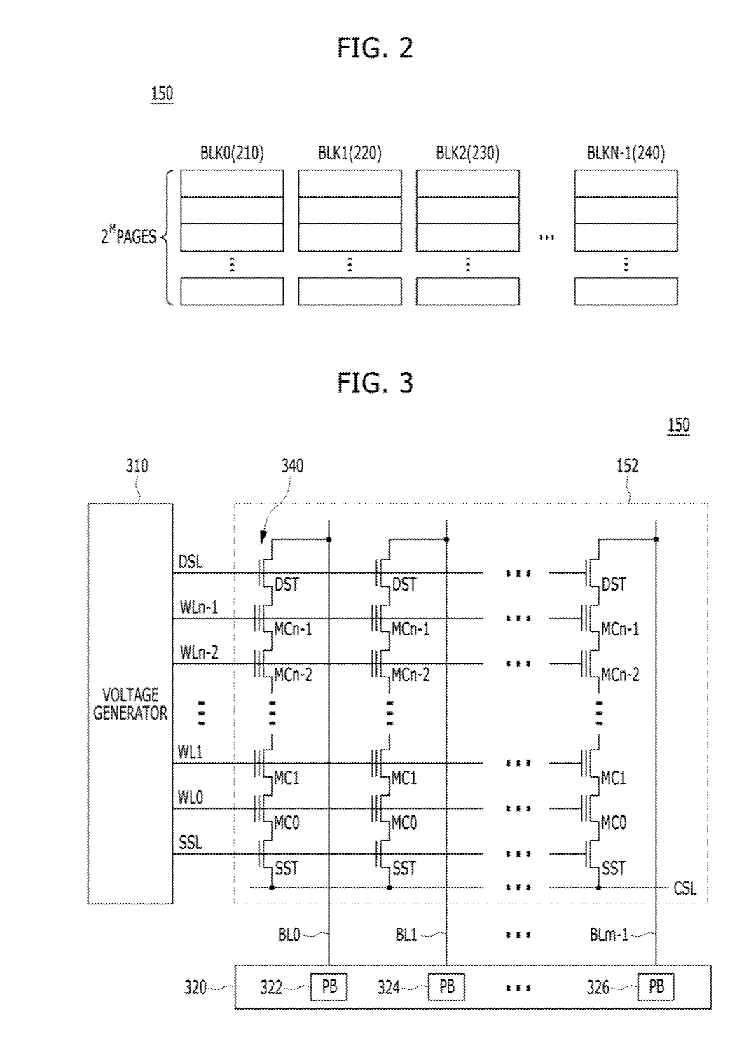

The memory device 150 of the memory system 110 may retain stored data when power supply is interrupted and, in particular, store the data provided from the host 102 during a write operation, and provide stored data to the host 102 during a read operation. The memory device 150 may include a plurality of memory blocks 152, 154 and 156. Each of the memory blocks 152, 154 and 156 may include a plurality of pages. Each of the pages may include a plurality of memory cells to which a plurality of word lines (WL) are electrically coupled. The memory device 150 may be a nonvolatile memory device, for example, a flash memory. The flash memory may have a three-dimensional (3D) stack structure. The structure of the memory device 150 and the three-dimensional (3D) stack structure of the memory device 150 will be described later in detail with reference to FIGS. 2 to 11.

The controller 130 of the memory system 110 may control the memory device 150 in response to a request from the host 102. The controller 130 may provide the data read from the memory device 150, to the host 102, and store the data provided from the host 102 into the memory device 150. As such, the controller 130 may control overall operations of the memory device 150, such as read, write, program and erase operations.

In detail, the controller 130 may include a host interface unit 132, a processor 134, an error correction code (ECC) unit 138, a power management unit 140, a NAND flash controller 142, and a memory 144.

The host interface unit 132 may process commands and data provided from the host 102, and may communicate with the host 102 through at least one of various interface protocols such as universal serial bus (USB), multimedia card (MMC), peripheral component interconnect-express (PCI-E), serial attached SCSI (SAS), serial advanced technology attachment (SATA), parallel advanced technology attachment (PATA), small computer system interface (SCSI), enhanced small disk interface (ESDI), and integrated drive electronics (IDE).

The ECC unit 138 may detect and correct errors in the data read from the memory device 150 during the read operation. The ECC unit 138 may not correct error bits when the number of the error bits is greater than or equal to a threshold number of correctable error bits, and the ECC unit 138 may output an error correction fall signal indicating failure in correcting the error bits.

The ECC unit 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and so on. The ECC unit 138 may include all circuits, systems or devices for the error correction operation.

The PMU 140 may provide and manage power for the controller 130 (e.g., power for the component elements included in the controller 130).

The NFC 142 may serve as a memory interface between the controller 130 and the memory device 150 to allow the controller 130 to control the memory device 150 in response to a request from the host 102. The NFC 142 may generate control signals for the memory device 150 and process data under the control of the processor 134 when the memory device 150 is a flash memory and, in particular, when the memory device 150 is a NAND flash memory.

The memory 144 may serve as a working memory of the memory system 110 and the controller 130, and store data for driving the memory system 110 and the controller 130. The controller 130 may control the memory device 150 in response to a request from the host 102. For example, the controller 130 may provide the data read from the memory device 150 to the host 102 and store the data provided from the host 102 in the memory device 150. When the controller 130 controls the operations of the memory device 150, the memory 144 may store data used by the controller 130 and the memory device 150 for such operations as read, write, program and erase operations.

The memory 144 may be implemented with volatile memory. The memory 144 may be implemented with a static random access memory (SRAM) or a dynamic random access memory (DRAM). As described above, the memory 144 may store data used by the host 102 and the memory device 150 for the read and write operations. To store the data, the memory 144 may include a program memory, a data memory, a write buffer, a read buffer, a map buffer, and so forth.

The processor 134 may control general operations of the memory system 110, as well as a write operation or a read operation for the memory device 150, in response to a write request or a read request from the host 102. The processor 134 may drive firmware, which is referred to as a flash translation layer (FTL), to control the general operations of the memory system 110. The processor 134 may be implemented with a microprocessor or a central processing unit (CPU).

A management unit (not shown) may be included in the processor 134, and may perform bad block management of the memory device 150. The management unit may find bad memory blocks included in the memory device 150, which are in unsatisfactory condition for further use, and perform bad block management on the bad memory blocks. When the memory device 150 is a flash memory (e.g., a NAND flash memory) a program failure may occur during the write operation (e.g., during the program operation) due to characteristics of a NAND logic function. During the bad block management, the data of the program-failed memory block or the bad memory block may be programmed into a new memory block. Also, the bad blocks seriously deteriorate the utilization efficiency of the memory device 150 having a 3D stack structure and the reliability of the memory system 100, and thus reliable bad block management is required.

FIG. 2 is a schematic diagram illustrating the memory device 150 shown in FIG. 1.

Referring to FIG. 2, the memory device 150 may include a plurality of memory blocks (e.g., zeroth to (N-1)^{th} blocks 210 to 240). Each of the plurality of memory blocks 210 to 240 may include a plurality of pages (e.g., 2^{M} number of pages (2^{M} PAGES)) to which the present invention is limited. Each of the plurality of pages may include a plurality of memory cells to which a plurality of word lines are electrically coupled.

The memory device 150 also may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data (e.g., two or more-bit data). An MLC memory block including a plurality of pages which are implemented with memory cells that are each capable of storing 3-bit data may be defined as a triple level cell (TLC) memory block.

Each memory block 210 to 240 stores the data provided from the host device 102 during a write operation, and provides stored data to the host 102 during a read operation.

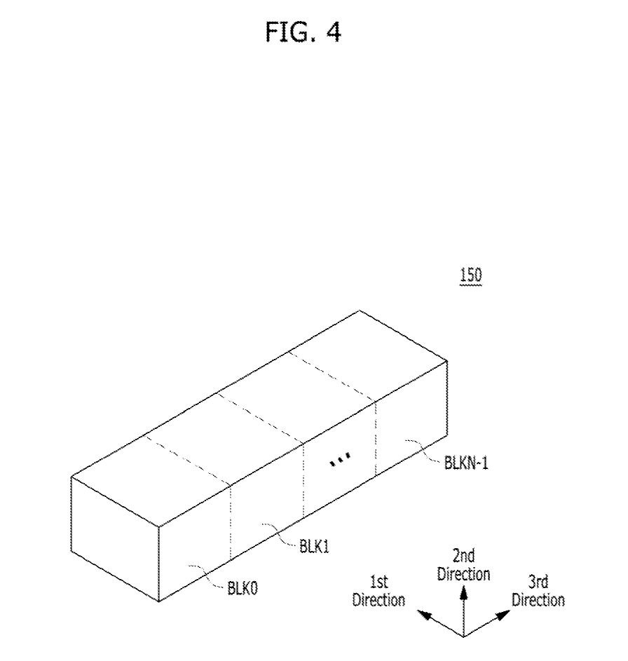

FIG. 3 is a circuit diagram illustrating one of the plurality of memory blocks 152 to 156 shown in FIG. 1.

Referring to FIG. 3, the memory block 152 of the memory device 150 may include a plurality of cell strings 340 which are electrically coupled to bit lines BL0 to BLm-1, respectively. The cell string 340 of each column may include at least one drain select transistor DST and at least one source select transistor SST. A plurality of memory cells or a plurality of memory cell transistors MC0 to MCn-1 are electrically coupled in series between the select transistors DST and SST. The respective memory cells MC0 to MCn-1 are configured by multi-level cells (MLC) each of which stores data information of a plurality of bits. The strings 340 are electrically coupled to the corresponding bit lines BL0 to BLm-1, respectively. For reference, in FIG. 3, ‘DSL’ denotes a drain select line, ‘SSL’ denotes a source select line, and ‘CSL’ denotes a common source line.

While FIG. 3 shows, as an example, the memory block 152 which is configured by NAND flash memory cells, it is to be noted that the memory block 152 of the memory device 150 in accordance with the embodiment is not limited to NAND flash memory and may be realized by NOR flash memory, hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A voltage supply block 310 of the memory device 150 provides word line voltages (e.g., a program voltage, a read voltage and/or a pass voltage) to be supplied to respective word lines according to an operation mode and provides voltages to be supplied to bulks (e.g., well regions in which the memory cells are formed). The voltage supply block 310 may perform a voltage generating operation under the control of a control circuit (not shown). The voltage supply block 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read/write circuit 320 of the memory device 150 is controlled by the control circuit, and serves as a sense amplifier or a write driver according to an operation mode. During a verification/normal read operation, the read/write circuit 320 serves as a sense amplifier for reading data from the memory cell array. Also, during a program operation, the read/write circuit 320 serves as a write driver that drives bit lines according to data to be stored in the memory cell array. The read/write circuit 320 receives data to be written in the memory cell array from a buffer (not shown) during the program operation, and drives the bit lines according to the inputted data. The read/write circuit 320 includes a plurality of page buffers 322, 324 and 326 respectively corresponding to columns (or bit lines) or pairs of columns (or pairs of bit lines). A plurality of latches (not shown) may be included in each of the page buffers 322, 324 and 326.

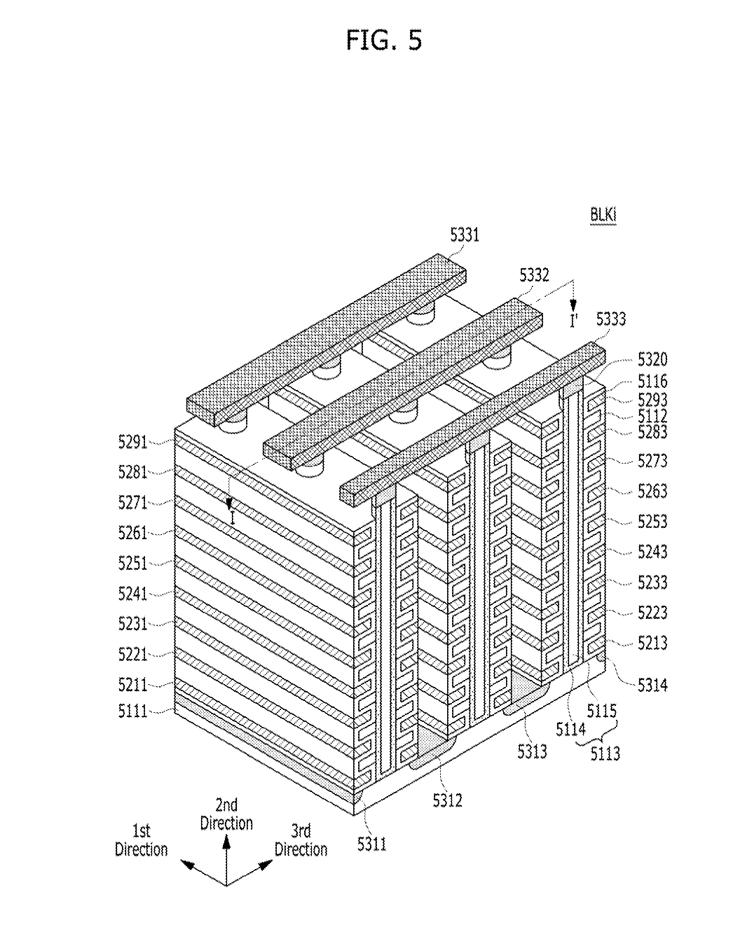

FIGS. 4 to 11 are schematic diagrams illustrating the memory device 150 shown in FIG. 1.

FIG. 4 is a block diagram illustrating an example of the plurality of memory blocks 152 to 156 of the memory device 150 shown in FIG. 1.

Referring to FIG. 4, the memory device 150 may include a plurality of memory blocks BLK0 to BLKN-1, and each of the memory blocks BLK0 to BLKN-1 may be realized in a three-dimensional (3D) structure or a vertical structure. The respective memory blocks BLK0 to BLKN-1 may include structures which extend in first to third directions (e.g., an x-axis direction, a y-axis direction and a z-axis direction).

The respective memory blocks BLK0 to BLKN-1 may include a plurality of NAND strings NS which extend in the second direction. The plurality of NAND strings NS may be provided in the first direction and the third direction. Each NAND string NS is electrically coupled to a bit line BL, at least one source select line SSL, at least one ground select line GSL, a plurality of word lines WL, at least one dummy word line DWL, and a common source line CSL. Namely, the respective memory blocks BLK0 to BLKN-1 is electrically coupled to a plurality of bit lines BL, a plurality of source select lines SSL, a plurality of ground select lines GSL, a plurality of word lines WL, a plurality of dummy word lines DWL, and a plurality of common source lines CSL.

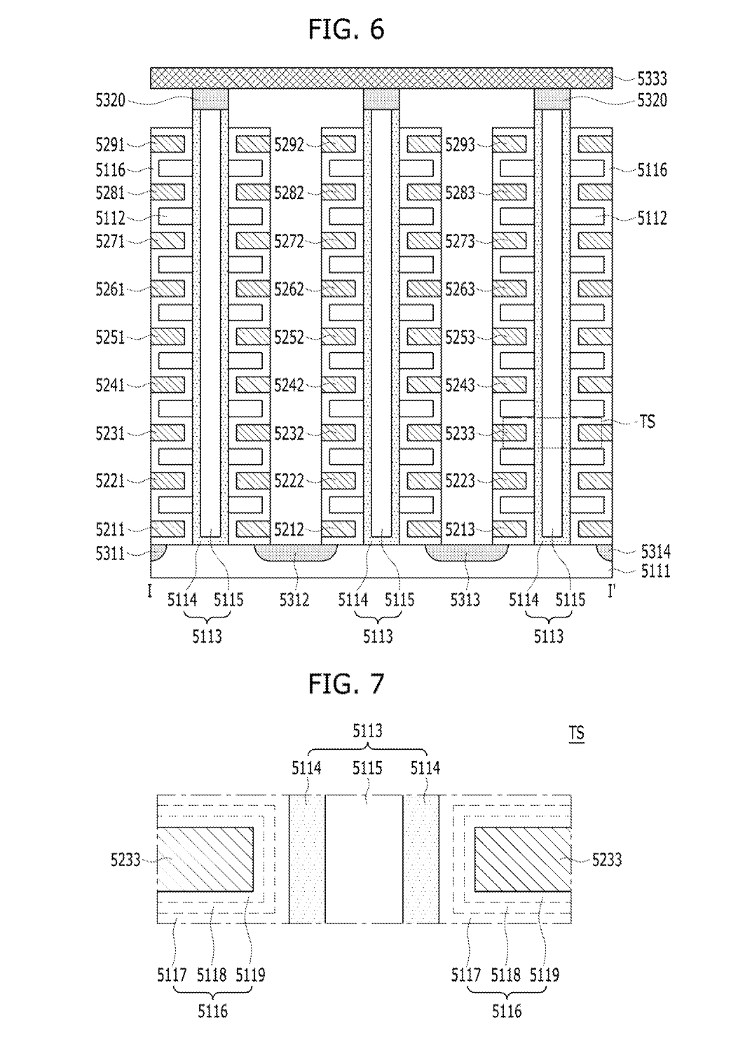

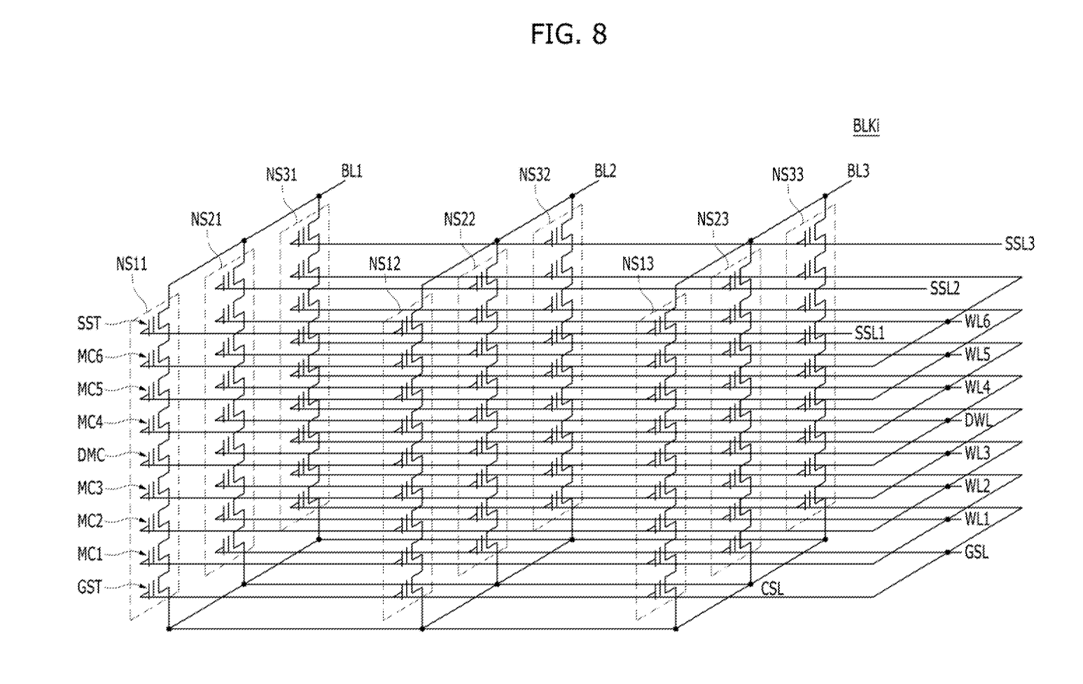

FIG. 5 is an isometric view of one BLKi of the plural memory blocks BLK0 to BLKN-1 shown in FIG. 4. FIG. 6 is a cross-sectional view taken along a line I-I′ of the memory block BLKi shown in FIG. 5.

Referring to FIGS. 5 and 6, a memory block BLKi among the plurality of memory blocks of the memory device 150 may include a structure which extends in the first to third directions.

A substrate 5111 may be provided. The substrate 5111 may include a silicon material doped with a first type impurity. The substrate 5111 may include a silicon material doped with a p-type impurity or may be a p-type well (e.g., a pocket p-well) and include an n-type well which surrounds the p-type well. While it is assumed that the substrate 5111 is p-type silicon, it is to be noted that the substrate 5111 is not limited to being p-type silicon.

A plurality of doping regions 5311 to 5314 which extend in the first direction may be provided over the substrate 5111. The plurality of doping regions 5311 to 5314 may contain a second type of impurity that is different from the substrate 5111. The plurality of doping regions 5311 to 5314 may be doped with an n-type impurity. While it is assumed here that first to fourth doping regions 5311 to 5314 are n-type, it is to be noted that the first to fourth doping regions 5311 to 5314 are not limited to being n-type.

In the region over the substrate 5111 between the first and second doping regions 5311 and 5312, a plurality of dielectric materials 5112 which extend in the first direction may be sequentially provided in the second direction. The dielectric materials 5112 and the substrate 5111 may be separated from one another by a predetermined distance in the second direction. The dielectric materials 5112 may be separated from one another by a predetermined distance in the second direction. The dielectric materials 5112 may include a dielectric material such as silicon oxide.

In the region over the substrate 5111 between the first and second doping regions 5311 and 5312, a plurality of pillars 5113 which are sequentially disposed in the first direction and pass through the dielectric materials 5112 in the second direction may be provided. The plurality of pillars 5113 may respectively pass through the dielectric materials 5112 and may be electrically coupled with the substrate 5111. Each pillar 5113 may be configured by a plurality of materials. The surface layer 5114 of each pillar 5113 may include a silicon material doped with the first type of impurity. The surface layer 5114 of each pillar 5113 may include a silicon material doped with the same type of impurity as the substrate 5111. While it is assumed here that the surface layer 5114 of each pillar 5113 may include p-type silicon, the surface layer 5114 of each pillar 5113 is not limited to being p-type silicon.

An inner layer 5115 of each pillar 5113 may be formed of a dielectric material. The inner layer 5115 of each pillar 5113 may be filled by a dielectric material such as silicon oxide.

In the region between the first and second doping regions 5311 and 5312, a dielectric layer 5116 may be provided along the exposed surfaces of the dielectric materials 5112, the pillars 5113 and the substrate 5111. The thickness of the dielectric layer 5116 may be less than half of the distance between the dielectric materials 5112. In other words, a region in which a material other than the dielectric material 5112 and the dielectric layer 5116 may be disposed, may be provided between (i) the dielectric layer 5116 provided over the bottom surface of a first dielectric material of the dielectric materials 5112 and (ii) the dielectric layer 5116 provided over the top surface of a second dielectric material of the dielectric materials 5112. The dielectric materials 5112 lie below the first dielectric material.

In the region between the first and second doping regions 5311 and 5312, conductive materials 5211 to 5291 may be provided over the exposed surface of the dielectric layer 5116. The conductive material 5211 which extends in the first direction may be provided between the dielectric material 5112 adjacent to the substrate 5111 and the substrate 5111. In particular, the conductive material 5211 which extends in the first direction may be provided between (i) the dielectric layer 5116 disposed over the substrate 5111 and (ii) the dielectric layer 5116 disposed over the bottom surface of the dielectric material 5112 adjacent to the substrate 5111.

The conductive material which extends in the first direction may be provided between (i) the dielectric layer 5116 disposed over the top surface of one of the dielectric materials 5112 and (ii) the dielectric layer 5116 disposed over the bottom surface of another dielectric material of the dielectric materials 5112, which is disposed over the certain dielectric material 5112. The conductive materials 5221 to 5281 which extend in the first direction may be provided between the dielectric materials 5112. The conductive material 5291 which extends in the first direction may be provided over the uppermost dielectric material 5112. The conductive materials 5211 to 5291 which extend in the first direction may be a metallic material. The conductive materials 5211 to 5291 which extend in the first direction may be a conductive material such as polysilicon.

In the region between the second and third doping regions 5312 and 5313, the same structures as the structures between the first and second doping regions 5311 and 5312 may be provided. For example, in the region between the second and third doping regions 5312 and 5313, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5212 to 5292 which extend in the first direction may be provided.

In the region between the third and fourth doping regions 5313 and 5314, the same structures as the structures between the first and second doping regions 5311 and 5312 may be provided. For example, in the region between the third and fourth doping regions 5313 and 5314, the plurality of dielectric materials 5112 which extend in the first direction, the plurality of pillars 5113 which are sequentially arranged in the first direction and pass through the plurality of dielectric materials 5112 in the second direction, the dielectric layer 5116 which is provided over the exposed surfaces of the plurality of dielectric materials 5112 and the plurality of pillars 5113, and the plurality of conductive materials 5213 to 5293 which extend in the first direction may be provided.

Drains 5320 may be respectively provided over the plurality of pillars 5113. The drains 5320 may be silicon materials doped with second type impurities. The drains 5320 may be silicon materials doped with n-type impurities. While it is assumed that the drains 5320 include n-type silicon, it is to be noted that the drains 5320 are not limited to being n-type silicon. For example, the width of each drain 5320 may be greater than the width of each corresponding pillar 5113. Each drain 5320 may be provided in the shape of a pad over the top surface of each corresponding pillar 5113.

Conductive materials 5331 to 5333 which extend in the third direction may be provided over the drains 5320. The conductive materials 5331 to 5333 may be sequentially disposed in the first direction. The respective conductive materials 5331 to 5333 may be electrically coupled with the drains 5320 of corresponding regions. The drains 5320 and the conductive materials 5331 to 5333 which extend in the third direction may be electrically coupled through contact plugs. The conductive materials 5331 to 5333 which extend in the third direction may be a metallic material. The conductive materials 5331 to 5333 which extend in the third direction may be a conductive material such as polysilicon.

In FIGS. 5 and 6, the respective pillars 5113 may form strings together with the dielectric layer 5116 and the conductive materials 5211 to 5291, 5212 to 5292 and 5213 to 5293 which extend in the first direction. The respective pillars 5113 may form NAND strings NS together with the dielectric layer 5116 and the conductive materials 5211 to 5291, 5212 to 5292 and 5213 to 5293 which extend in the first direction. Each NAND string NS may include a plurality of transistor structures TS.

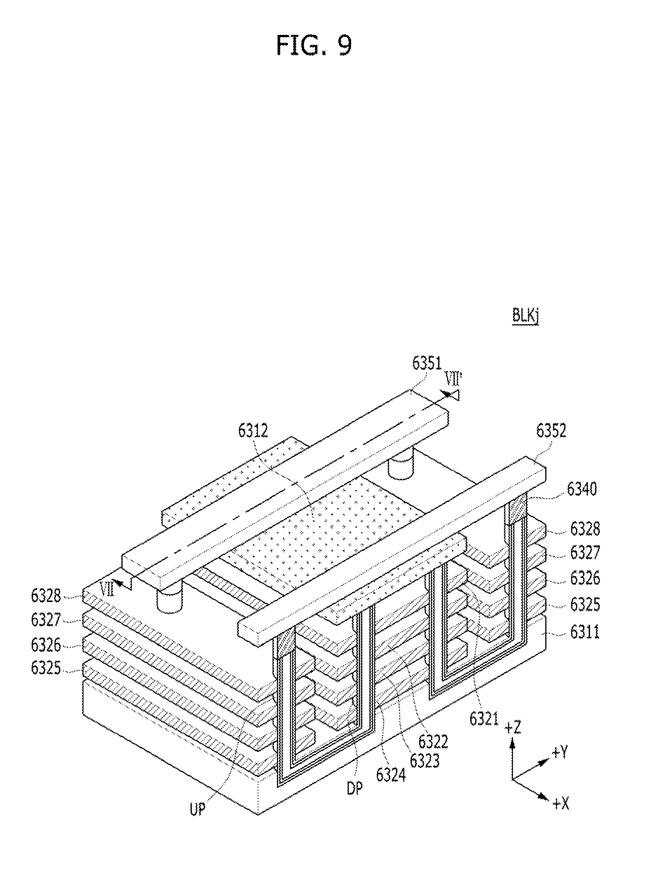

FIG. 7 is a cross-sectional view of the transistor structure TS shown in FIG. 6.

Referring to FIG. 7, in the transistor structure TS shown in FIG. 6, the dielectric layer 5116 may include first to third sub dielectric layers 5117, 5118 and 5119.

The surface layer 5114 of p-type silicon in each of the pillars 5113 may serve as a body. The first sub dielectric layer 5117 adjacent to the pillar 5113 may serve as a tunneling dielectric layer, and may include a thermal oxidation layer.

The second sub dielectric layer 5118 may serve as a charge storing layer. The second sub dielectric layer 5118 may serve as a charge capturing layer, and may include a nitride layer or a metal oxide layer such as an aluminum oxide layer, a hafnium oxide layer, or the like.

The third sub dielectric layer 5119 adjacent to the conductive material 5233 may serve as a blocking dielectric layer. The third sub dielectric layer 5119 adjacent to the conductive material 5233 which extends in the first direction may be formed as a single layer or multiple layers. The third sub dielectric layer 5119 may be a high-k dielectric layer (e.g., an aluminum oxide layer, a hafnium oxide layer, etc.) that has a dielectric constant greater than the first and second sub dielectric layers 5117 and 5118.

The conductive material 5233 may serve as a gate or a control gate. That is, the gate or the control gate 5233, the blocking dielectric layer 5119, the charge storing layer 5118, the tunneling dielectric layer 5117 and the body 5114 may form a transistor or a memory cell transistor structure. For example, the first to third sub dielectric layers 5117 to 5119 may form an oxide-nitride-oxide (ONO) structure. In the embodiment, the surface layer 5114 of p-type silicon in each of the pillars 5113 will be referred to as a body in the second direction.

The memory block BLKi may include the plurality of pillars 5113. Namely, the memory block BLKi may include the plurality of NAND strings NS. In detail, the memory block BLKi may include the plurality of NAND strings NS which extend in the second direction or a direction perpendicular to the substrate 5111.

Each NAND string NS may include the plurality of transistor structures TS which are disposed in the second direction. At least one of the plurality of transistor structures TS of each NAND string NS may serve as a string source transistor SST. At least one of the plurality of transistor structures TS of each NAND string NS may serve as a ground select transistor GST.

The gates or control gates may correspond to the conductive materials 5211 to 5291, 5212 to 5292 and 5213 to 5293 which extend in the first direction. In other words, the gates or the control gates may extend in the first direction and form word lines and at least two select lines, at least one source select line SSL and at least one ground select line GSL.

The conductive materials 5331 to 5333 which extend in the third direction may be electrically coupled to one end of the NAND strings NS. The conductive materials 5331 to 5333 which extend in the third direction may serve as bit lines BL. That is, in one memory block BLKi, the plurality of NAND strings NS may be electrically coupled to one bit line BL.

The second type doping regions 5311 to 5314 which extend in the first direction may be provided to the other ends of the NAND strings NS. The second type doping regions 5311 to 5314 which extend in the first direction may serve as common source lines CSL.

Namely, the memory block BLKi may include a plurality of NAND strings NS which extend in a direction perpendicular to the substrate 5111 (e.g., the second direction) and may serve as a NAND flash memory block (e.g., of a charge capturing type memory) to which a plurality of NAND strings NS are electrically coupled to one bit line BL.

While it is illustrated in FIGS. 5 to 7 that the conductive materials 5211 to 5291, 5212 to 5292 and 5213 to 5293 which extend in the first direction are provided in 9 layers, it is to be noted that the conductive materials 5211 to 5291, 5212 to 5292 and 5213 to 5293 which extend in the first direction are not limited to being provided in 9 layers. For example, conductive materials which extend in the first direction may be provided in 8 layers, 16 layers or any multiple of layers. In other words, in one NAND string NS, the number of transistors may be 8, 16 or more.

While it is illustrated in FIGS. 5 to 7 that 3 NAND strings NS are electrically coupled to one bit line BL, it is to be noted that the embodiment is not limited to having 3 NAND strings NS that are electrically coupled to one bit line BL. In the memory block BLKi, m number of NAND strings NS may be electrically coupled to one bit line BL, m being a positive integer. According to the number of NAND strings NS which are electrically coupled to one bit line BL, the number of conductive materials 5211 to 5291, 5212 to 5292 and 5213 to 5293 which extend in the first direction and the number of common source lines 5311 to 5314 may be controlled as well.

Further, while it is illustrated in FIGS. 5 to 7 that 3 NAND strings NS are electrically coupled to one conductive material which extends in the first direction, it is to be noted that the embodiment is not limited to having 3 NAND strings NS electrically coupled to one conductive material which extends in the first direction. For example, n number of NAND strings NS may be electrically coupled to one conductive material which extends in the first direction, n being a positive integer. According to the number of NAND strings NS which are electrically coupled to one conductive material which extends in the first direction, the number of bit lines 5331 to 5333 may be controlled as well.

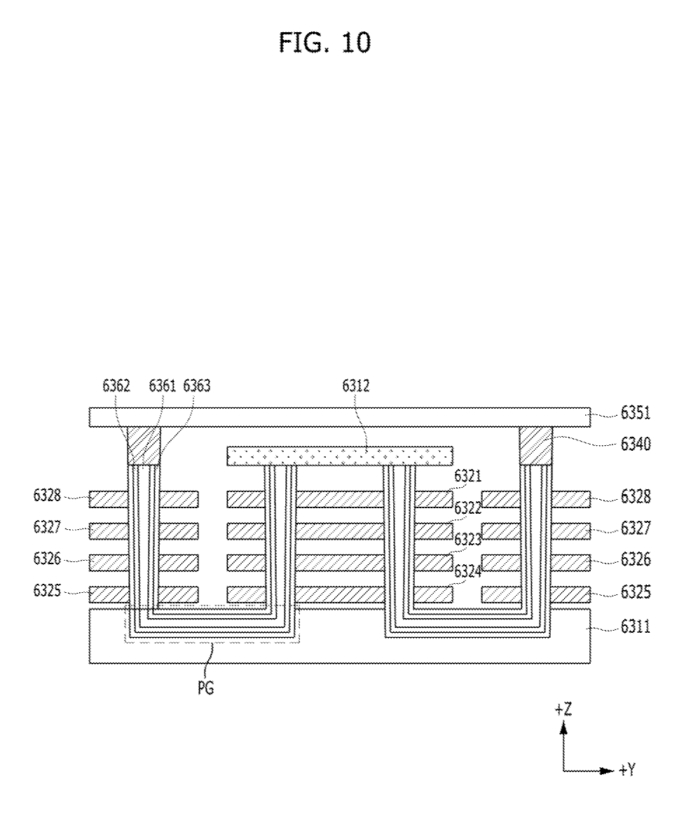

FIG. 8 is an equivalent circuit diagram illustrating the memory block BLKi having a first structure described with reference to FIGS. 5 to 7.

Referring to FIG. 8, in a block BLKi having the first structure, NAND strings NS11 to NS31 may be provided between a first bit line BL1 and a common source line CSL. The first bit line BL1 may correspond to the conductive material 5331 of FIGS. 5 and 6, which extends in the third direction. NAND strings NS12 to NS32 may be provided between a second bit line BL2 and the common source line CSL. The second bit line BL2 may correspond to the conductive material 5332 of FIGS. 5 and 6, which extends in the third direction. NAND strings NS13 to NS33 may be provided between a third bit line BL3 and the common source line CSL. The third bit line BL3 may correspond to the conductive material 5333 of FIGS. 5 and 6, which extends in the third direction.

A source select transistor SST of each NAND string NS may be electrically coupled to a corresponding bit line BL. A ground select transistor GST of each NAND string NS may be electrically coupled to the common source line CSL. Memory cells MC may be provided between the source select transistor SST and the ground select transistor GST of each NAND string NS.

In this example, NAND strings NS are defined by units of rows and columns and NAND strings NS which are electrically coupled to one bit line may form one column. The NAND strings NS11 to NS31 which are electrically coupled to the first bit line BL1 correspond to a first column, the NAND strings NS12 to NS32 which are electrically coupled to the second bit line BL2 correspond to a second column, and the NAND strings NS13 to NS33 which are electrically coupled to the third bit line 6L3 correspond to a third column. NAND strings NS which are electrically coupled to one source select line SSL form one row. The NAND strings NS11 to NS13 which are electrically coupled to a first source select line SSL1 form a first row, the NAND strings NS21 to NS23 which are electrically coupled to a second source select line SSL2 form a second row, and the NAND strings NS31 to NS33 which are electrically coupled to a third source select line SSL3 form a third row.

In each NAND string NS, a height is defined. In each NAND string NS, the height of a memory cell MC1 adjacent to the ground select transistor GST has a value ‘1’. In each NAND string NS, the height of a memory cell increases as the memory cell gets closer to the source select transistor SST when measured from the substrate 5111. In each NAND string NS, the height of a memory cell MC6 adjacent to the source select transistor SST is 7.

The source select transistors SST of the NAND strings NS in the same row share the source select line SSL. The source select transistors SST of the NAND strings NS in different rows are respectively electrically coupled to the different source select lines SSL1, SSL2 and SSL3.

The memory cells at the same height in the NAND strings NS in the same row share a word line WL. That is, at the same height, the word lines WL electrically coupled to the memory cells MC of the NAND strings NS in different rows are electrically coupled. Dummy memory cells DMC at the same height in the NAND strings NS of the same row share a dummy word line DWL. Namely, at the same height or level, the dummy word lines DWL electrically coupled to the dummy memory cells DMC of the NAND strings NS in different rows are electrically coupled.

The word lines WL or the dummy word lines DWL located at the same level or height or layer are electrically coupled with one another at layers where the conductive materials 5211 to 5291, 5212 to 5292 and 5213 to 5293 which extend in the first direction are provided. The conductive materials 5211 to 5291, 5212 to 5292 and 5213 to 5293 which extend in the first direction are electrically coupled in common to upper layers through contacts. At the upper layers, the conductive materials 5211 to 5291, 5212 to 5292 and 5213 to 5293 which extend in the first direction are electrically coupled. In other words, the ground select transistors GST of the NAND strings NS in the same row share the ground select line GSL. Further, the ground select transistors GST of the NAND strings NS in different rows share the ground select line GSL. That is, the NAND strings NS11 to NS13, NS21 to NS23 and NS31 to NS33 are electrically coupled to the ground select line GSL.

The common source line CSL is electrically coupled to the NAND strings NS. Over the active regions and over the substrate 5111, the first to fourth doping regions 5311 to 5314 are electrically coupled. The first to fourth doping regions 5311 to 5314 are electrically coupled to an upper layer through contacts and, at the upper layer, the first to fourth doping regions 5311 to 5314 are electrically coupled.

As shown in FIG. 8, the word lines WL of the same height or level are electrically coupled. Accordingly, when a word line WL at a specific height is selected, all NAND strings NS which are electrically coupled to the word line WL are selected. The NAND strings NS in different rows are electrically coupled to different source select lines SSL. Accordingly, among the NAND strings NS electrically coupled to the same word line WL, by selecting one of the source select lines SSL1 to SSL3, the NAND strings NS in the unselected rows are electrically isolated from the bit lines BL1 to BL3. In other words, by selecting one of the source select lines SSL1 to SSL3, a row of NAND strings NS is selected. Moreover, by selecting one of the bit lines BL1 to BL3, the NAND strings NS in the selected rows are selected in units of columns.

In each NAND string NS, a dummy memory cell DMC is provided. In FIG. 8, the dummy memory cell DMC is provided between a third memory cell MC3 and a fourth memory cell MC4 in each NAND string NS. That is, first to third memory cells MC1 to MC3 are provided between the dummy memory cell DMC and the ground select transistor GST. Fourth to sixth memory cells MC4 to MC6 are provided between the dummy memory cell DMC and the source select transistor SST. The memory cells MC of each NAND string NS are divided into memory cell groups by the dummy memory cell DMC. In the divided memory cell groups, memory cells (e.g., MC1 to MC3) adjacent to the ground select transistor GST may be referred to as a lower memory cell group, and memory cells (e.g., MC4 to MC6) adjacent to the string select transistor SST may be referred to as an upper memory cell group.

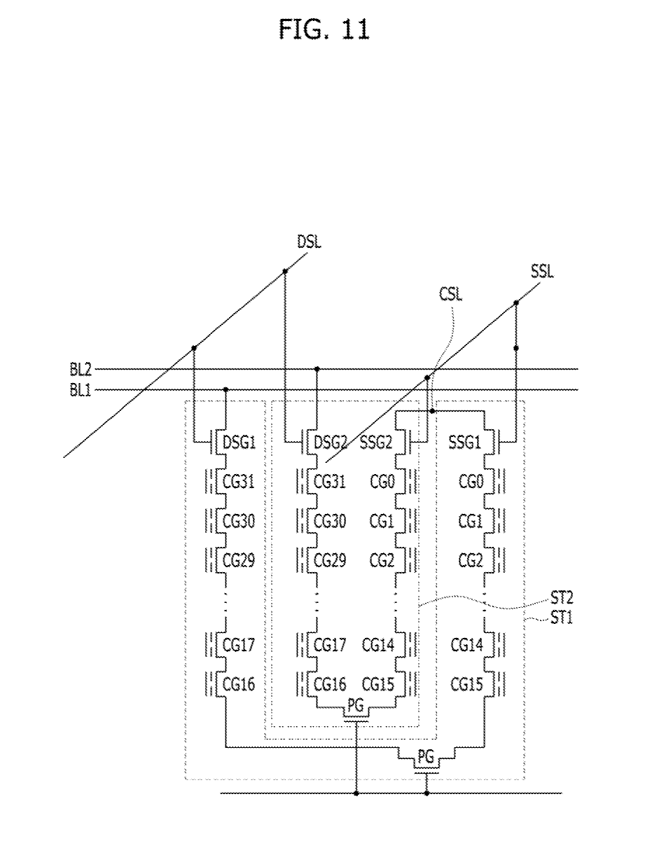

Herein, detailed descriptions will be made with reference to FIGS. 9 to 11, which show the memory device in the memory system in accordance with an embodiment implemented with a three-dimensional (3D) nonvolatile memory device different from the first structure.

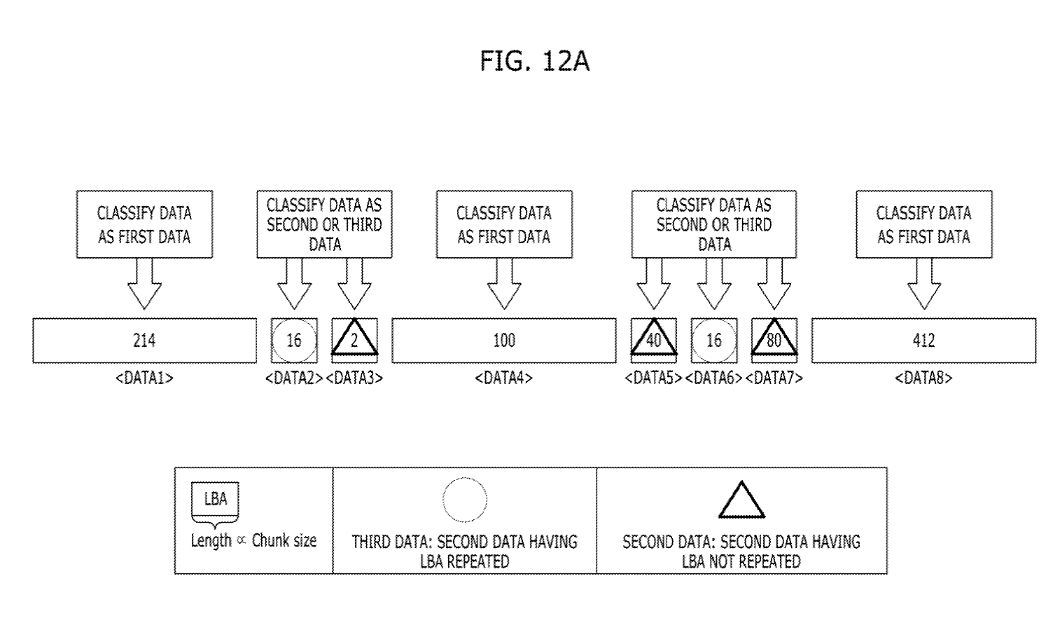

FIG. 9 is an isometric view schematically illustrating the memory device implemented with the three-dimensional (3D) nonvolatile memory device and showing a memory block BLKj of the plurality of memory blocks of FIG. 4. FIG. 10 is a cross-sectional view illustrating the memory block BLKj taken along the line VII-VII′ of FIG. 9.

Referring to FIGS. 9 and 10, the memory block BLKj among the plurality of memory blocks of the memory device 150 of FIG. 1 may include structures which extend in the first to third directions.

A substrate 6311 may be provided. For example, the substrate 6311 may include a silicon material doped with a first type impurity. For example, the substrate 6311 may include a silicon material doped with a p-type impurity or may be a p-type well (e.g., a pocket p-well) and include an n-type well which surrounds the p-type well. While it is assumed in the embodiment that the substrate 6311 is p-type silicon, it is to be noted that the substrate 6311 is not limited to being p-type silicon.

First to fourth conductive materials 6321 to 6324 which extend in the x-axis direction and the y-axis direction may be provided over the substrate 6311. The first to fourth conductive materials 6321 to 6324 may be separated by a predetermined distance in the z-axis direction.

Fifth to eighth conductive materials 6325 to 6328 which extend in the x-axis direction and the y-axis direction may be provided over the substrate 6311. The fifth to eighth conductive materials 6325 to 6328 may be separated by the predetermined distance in the z-axis direction. The fifth to eighth conductive materials 6325 to 6328 may be separated from the first to fourth conductive materials 6321 to 6324 in the y-axis direction.

A plurality of lower pillars DP which pass through the first to fourth conductive materials 6321 to 6324 may be provided. Each lower pillar DP extends in the z-axis direction. Also, a plurality of upper pillars UP which pass through the fifth to eighth conductive materials 6325 to 6328 may be provided. Each upper pillar UP extends in the z-axis direction.

Each of the lower pillars DP and the upper pillars UP may include an internal material 6361, an intermediate layer 6362, and a surface layer 6363. The intermediate layer 6362 may serve as a channel of the cell transistor. The surface layer 6363 may include a blocking dielectric layer, a charge storing layer and a tunneling dielectric layer.

The lower pillar DP and the upper pillar UP may be electrically coupled through a pipe gate PG. The pipe gate PG may be disposed in the substrate 6311. For instance, the pipe gate PG may include the same material as the lower pillar DP and the upper pillar UP.

A doping material 6312 of a second type which extends in the x-axis direction and the y-axis direction may be provided over the lower pillars DP. For example, the doping material 6312 of the second type may include an n-type silicon material. The doping material 6312 of the second type may serve as a common source line CSL.

Drains 6340 may be provided over the upper pillars UP. The drains 6340 may include an n-type silicon material. First and second upper conductive materials 6351 and 6352 which extend in the y-axis direction may be provided over the drains 6340.

The first and second upper conductive materials 6351 and 6352 may be separated in the x-axis direction. The first and second upper conductive materials 6351 and 6352 may be formed of a metal. The first and second upper conductive materials 6351 and 6352 and the drains 6340 may be electrically coupled through contact plugs. The first and second upper conductive materials 6351 and 6352 respectively serve as first and second bit lines BL1 and BL2.

The first conductive material 6321 may serve as a source select line SSL, the second conductive material 6322 may serve as a first dummy word line DWL1, and the third and fourth conductive materials 6323 and 6324 serve as first and second main word lines MWL1 and MWL2, respectively. The fifth and sixth conductive materials 6325 and 6326 serve as third and fourth main word lines MWL3 and MWL4, respectively, the seventh conductive material 6327 may serve as a second dummy word line DWL2, and the eighth conductive material 6328 may serve as a drain select line DSL.

The lower pillar DP and the first to fourth conductive materials 6321 to 6324 adjacent to the lower pillar DP form a lower string. The upper pillar UP and the fifth to eighth conductive materials 6325 to 6328 adjacent to the upper pillar UP form an upper string. The lower string and the upper string may be electrically coupled through the pipe gate PG. One end of the lower string may be electrically coupled to the doping material 6312 of the second type which serves as the common source line CSL. One end of the upper string may be electrically coupled to a corresponding bit line through the drain 6340. One lower string and one upper string form one cell string which is electrically coupled between the doping material 6312 of the second type serving as the common source line CSL and a corresponding one of the upper conductive material layers 6351 and 6352 serving as the bit line BL.

That is, the lower string may include a source select transistor SST, the first dummy memory cell DMC1, and the first and second main memory cells MMC1 and MMC2. The upper string may include the third and fourth main memory cells MMC3 and MMC4, the second dummy memory cell DMC2, and a drain select transistor DST.

In FIGS. 9 and 10, the upper string and the lower string may form a NAND string NS, and the NAND string NS may include a plurality of transistor structures TS. Since the transistor structure included in the NAND string NS in FIGS. 9 and 10 is described above in detail with reference to FIG. 7, a detailed description thereof will be omitted herein.

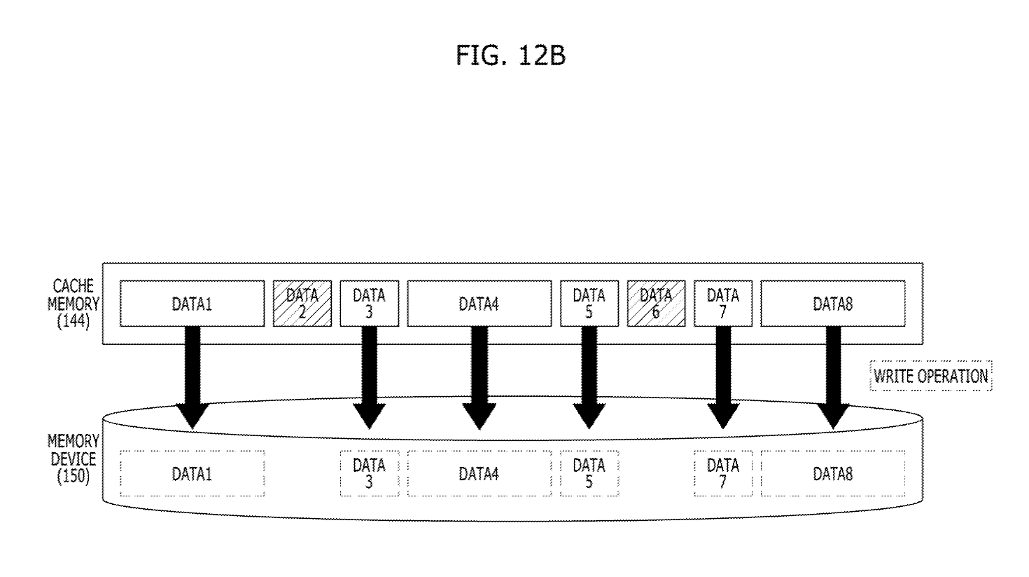

FIG. 11 is a circuit diagram illustrating the equivalent circuit of the memory block BLKj having the second structure as described above with reference to FIGS. 9 and 10A first string and a second string, which form a pair in the memory block BLKj in the second structure are shown.

Referring to FIG. 11, in the memory block BLKj having the second structure among the plurality of blocks of the memory device 150, cell strings, each of which is implemented with one upper string and one lower string electrically coupled through the pipe gate PG as described above with reference to FIGS. 9 and 10, is provided in such a way as to define a plurality of pairs.

In the certain memory block BLKj having the second structure, memory cells CG0 to CG31 stacked along a first channel CH1 (not shown) (e.g., at least one source select gate SSG1 and at least one drain select gate DSG1) form a first string ST1, and memory cells CG0 to CG31 stacked along a second channel CH2 (not shown) (e.g., at least one source select gate SSG2 and at least one drain select gate DSG2) form a second string ST2.

The first string ST1 and the second string ST2 are electrically coupled to the same drain select line DSL and the same source select line SSL. The first string ST1 is electrically coupled to a first bit line BL1, and the second string ST2 is electrically coupled to a second bit line BL2.

While it is described in FIG. 11 that the first string ST1 and the second string ST2 are electrically coupled to the same drain select line DSL and the same source select line SSL, it is contemplated that the first string ST1 and the second string ST2 may be electrically coupled to the same source select line SSL and the same bit line BL, the first string ST1 may be electrically coupled to a first drain select line DSL1 and the second string ST2 may be electrically coupled to a second drain select line DSL2. Further it is contemplated that the first string ST1 and the second string ST2 may be electrically coupled to the same drain select line DSL and the same bit line BL, the first string ST1 may be electrically coupled to a first source select line SSL1 and the second string ST2 may be electrically coupled a second source select line SSL2.

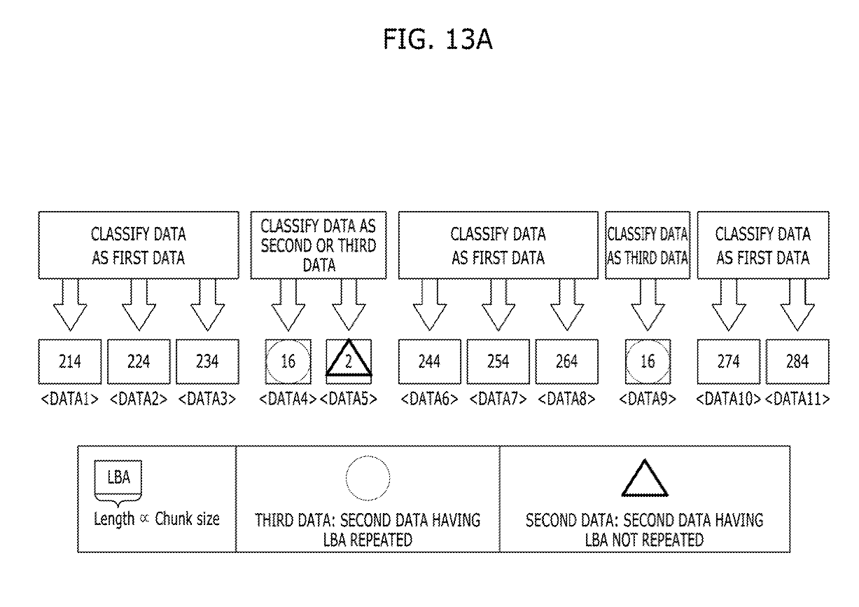

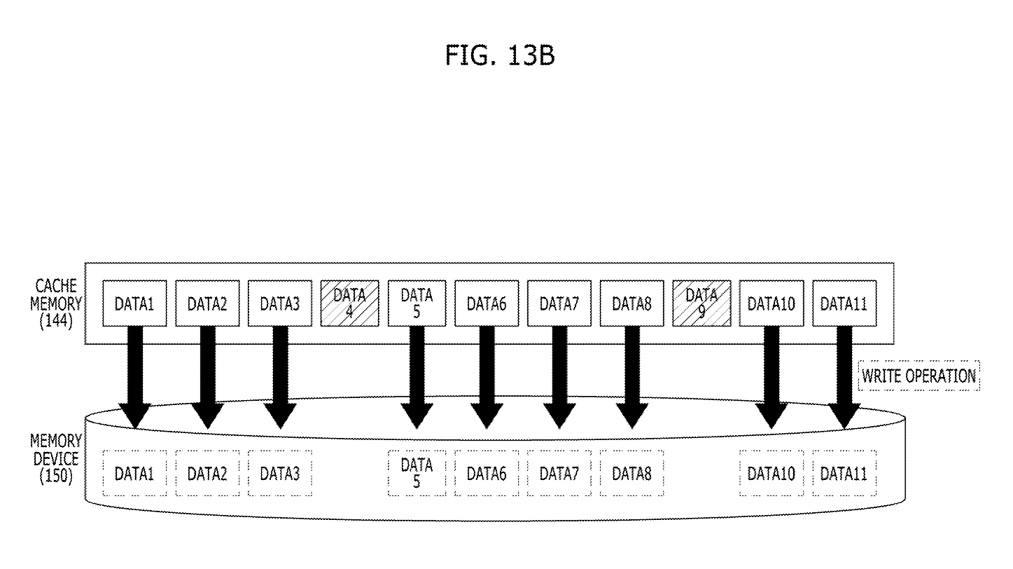

FIGS. 12A and 12B and FIGS. 13A and 13B are diagrams illustrating a method of classifying data provided from the host in the memory system 110 in accordance with an embodiment of the present invention.

FIGS. 12A and 13A show how the controller 130 classifies data DATA<1:8> or DATA<1:11> provided from the host 102. FIGS. 12B and 13B show how the classified data DATA<1:8> or DATA<1:11> are stored in the memory 144 in the controller 130 and the memory device 150 of the memory system 110.

As described above, the memory 144 of the controller 130 includes a space for storing other data for data read/write operations as in a “mapping table” in addition to a space for temporarily storing data as “cache memory.” Furthermore, FIGS. 12A and 12B and FIGS. 13A and 13B show that the length of each of the data DATA<1:8> or DATA<1:11> provided from the host 102 is proportional to a chunk thereof. That is, data having a relatively long length is shown as data having a relatively large chunk. In FIGS. 12A and 13A, a reference number shown in the middle of boxes representing the data DATA<1:8> or DATA<1:11> represents the value of the logical address LBA of each of the data DATA<1:8> or DATA<1:11>.

Referring to FIG. 12A, the controller 130 classifies the data DATA<1:8>, provided from the host 102, as first classification data of relatively greater size or second classification data of relatively smaller size with reference to a reference size.

For example, as shown in the drawings, when a total of the 8 data DATA<1:8> are sequentially provided from the host 102, the controller 130 performs an operation for classifying the 8 data DATA<1:8> as the first classification data or the second classification data by determining whether the each size of the 8 data DATA<1:8> is greater than or smaller than the reference size.

For example, each of the first data DATA<1>, the fourth data DATA<4>, and the eighth data DATA<8> has a relatively large size. In contrast, each of the second and the third data DATA<2:3> and the fifth to seventh data DATA<5:7> has a relatively small size.

Accordingly, the first data DATA<1>, the fourth data DATA<4>, and the eighth data DATA<8> are classified as the first classification data. In contrast, the second and the third data DATA<2:3> and the fifth to seventh data DATA<5:7> are classified as the second classification data.

Furthermore, the controller 130 classifies one or more of the second classification data, which is repeatedly provided more than a threshold value of repetition, as third classification data.

The repetitive provision of the second classification data may be checked through the value of the logical address LBA of the second classification data.

As depicted in FIG. 12A, the values of the logical addresses LBA of the second and the third data DATA<2:3> and the fifth to seventh data DATA<5:7> classified as the second classification data are respectively “16”, “2”, “40”, “16”, and “80.” The logical addresses LBA of the second data DATA<2> and the seventh data DATA<6> have the same value of “16” and all the logical addresses LBA of the third data DATA<3>, the fifth data DATA<5>, and the seventh data DATA<7> have different values.

In this case, assuming that the threshold value of repetition is “2”, the second data DATA<2> and the seventh data DATA<6> are classified as the third classification data. All the third data DATA<3>, the fifth data DATA<5>, and the seventh data DATA<7> are classified as the second classification data.

Although not directly shown in the drawings, there is a LBA storage space for storing the logical address LBA of each of the second classification data. The controller 130 accumulates and stores the logical addresses LBA of the second classification data in the LBA storage space, and classifies one or more of the second classification data having the accumulated number of the logical address LBA greater than the threshold value of repetition as the third classification data. The LBA storage space may be a specific space within the memory 144 or may be a separate register.

The third classification data may be metadata.

The third classification data has the following three characteristics as the metadata.

A first characteristic is the size of metadata. In general, the size of metadata does not exceed the reference size because the internal data format of the metadata has been previously determined. The third classification data is a subset of the second classification data of the relatively smaller size. Therefore, the third classification data has a high probability of the metadata.

A second characteristic is the repetitive provision of the metadata. In general, metadata is provided along with user data, which may be classified as the first classification data, because the metadata is indicative of configuration information or associated information about the user data or the first classification data. In general, the user data or the first classification data is repetitively provided more than an adequate number of times along with the metadata. The third classification data is data repeatedly provided more than the threshold value of repetition. Therefore, the third classification data has a high probability of the metadata.

A third characteristic is usage of the same logical address LBA of the metadata. In general, the logical address LBA of metadata is fixed. As described above, the third classification data is data repeatedly provided with the same logical address LBA for more than the threshold value of repetition. Therefore, the third classification data has a high probability of the metadata.

Accordingly, the third classification data of the relatively smaller size and of the repetitive provision for more than the threshold value of repetition has a high probability of the metadata.

Referring to FIG. 12B, the first data DATA<1>, the third to fifth data DATA<3:5>, and the seventh and the eighth data DATA<7:8> of the 8 data DATA<1:8> that are classified as the first and the second classification data are stored in the memory device 150 without a change during the write operation after they are stored in the memory 144.

In contrast, the second data DATA<2> and the seventh data DATA<6> of the 8 data DATA<1:8> that are classified as the third classification data are not written into the memory device 150 during the write operation after they are stored in the memory 144.

That is, the first classification data and the second classification data are written into the memory device 150 having a relatively sufficient space and relatively slow input/output speed.

In contrast, the third classification data is metadata that needs to be input/output very frequently. Accordingly, the third classification data is not stored in the memory device 150 but in the memory 144 having a relatively small space and relatively fast input/output speed.

As described above, in the memory system in accordance with an embodiment of the present invention, data classified as the third classification data is managed only in the memory 144.

FIG. 12A shows a bulk of data having a relatively greater length as the first classification data. In contrast, FIG. 13A shows a series of data, each of which has a relatively smaller length, as the first classification data. FIG. 12A shows a bulk of data having a size greater than a first reference size as the first classification data while FIG. 13A shows a series of data, each of which has a size smaller than the first reference size and greater than a second reference size, as the first classification data.

Referring to FIG. 12A, the first data DATA<1>, the fourth data DATA<4>, and the eighth data DATA<8>, respectively have logical addresses LBA of “214”, “100”, and “412”, which are random. Accordingly, FIG. 12A shows a bulk of data having a relatively greater length and random logical address LBA as the first classification data.

In contrast, referring to FIG. 13A, the first to third data DATA<1:3>, the sixth to eighth data DATA<6:8>, and the tenth and the eleventh data DATA<10:11> respectively have logical addresses LBA of “214”, “224”, “234”, “244”, “254”, “264”, “274”, and “284”, which continuously increase with an interval value of “10”. Accordingly, FIG. 13A shows a series of data, each of which has a relatively smaller length, and the logical addresses LBA of which have continuous values, as the first classification data.

The reference size for determining the first classification data may vary according to the random value or the continuous value of the logical address LBA. A bulk of data having a size greater than the first reference size while having the random value of the logical address LBA is classified as the first classification data as described with reference to FIGS. 12A and 12B. Also, a series of data, each of which has a size smaller than the first reference size and greater than the second reference size, and the logical addresses LBA of which have continuous values, as the first classification data as shown in FIGS. 13A and 13B.

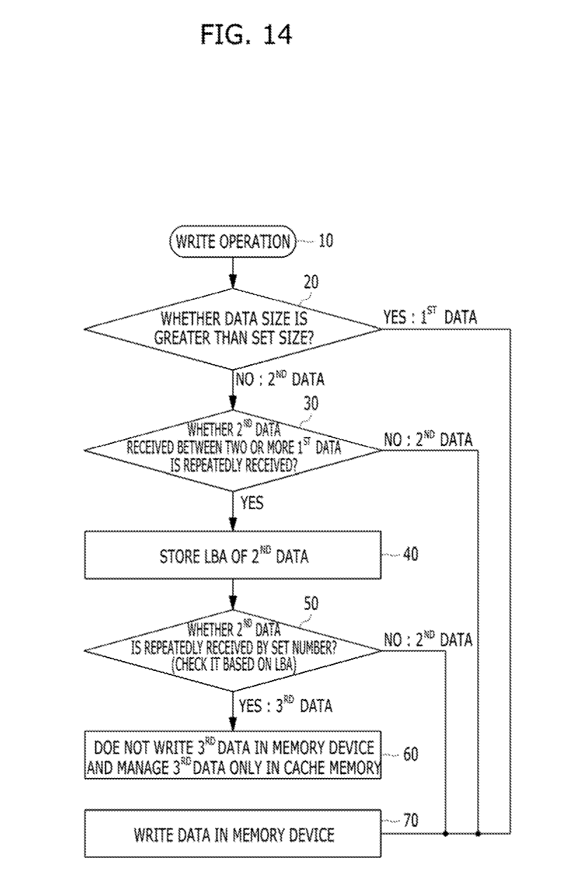

FIG. 14 is a flowchart illustrating the method of classifying data provided from the host 102 in the memory system 110 in accordance with an embodiment of the present invention.

When a write operation starts, the data DATA<1:8> or DATA<1:11> is sequentially provided from the host 102 at step 10.

Accordingly, the controller 130 determines whether the size of each of the data DATA<1:8> or DATA<1:11> provided from the host 102 is greater than or smaller than a reference size at step 20. As a result of the determination of step 20, data having a size greater than the reference size is classified as the first classification data (“YES” at step 20). As a result of the determination of step 20, data having a size smaller than the reference size is classified as the second classification data (“NO” at step 20). The reference size for classification of the first classification data or the second classification data may vary according to the random value or the continuous value of the logical address LBA, as described with reference to FIGS. 12A and 13A.

The first classification data is written in the memory device 150 at step 70. The first classification data will be temporarily stored in the memory 144 before it is written in the memory device 150.

It is determined at step 30 whether the second classification data is provided between two or more first classification data and is repeatedly provided more than the threshold value of repetition.

When the second classification data is not provided between two or more first classification data more than the threshold value of repetition (“NO” at step 30), the second classification data is written into the memory device 150 at step 70. The second classification data will be temporarily stored in the memory 144 before it is written in the memory device 150.

When the second classification data is provided between two or more first classification data more than the threshold value of repetition (“YES” at step 30), the logical address LBA of the second classification data is stored in the LBA storage space at step 40.

As described above, the controller 130 classifies one or more of the second classification data, which is repeatedly provided more than the threshold value of repetition, as the third classification data. The controller 130 accumulates and stores the logical addresses LBA of the second classification data in the LBA storage space at step 40. The controller 130 classifies one or more of the second classification data having the accumulated number of the logical address LBA greater than the threshold value of repetition as the third classification data through determination whether the accumulated number of the logical address LBA in the LBA storage space is greater than the threshold value of repetition at step 50.

When the accumulated number of the logical address LBA in the LBA storage space is smaller than the threshold value of repetition (“NO” at step 50), the second classification data is written into the memory device 150 at step 70. The second classification data will be temporarily stored in the memory 144 before it is written in the memory device 150.

When the accumulated number of the logical address LBA in the LBA storage space is greater than the threshold value of repetition (“YES” at step 50), the second classification data is classified as the third classification data. The third classification data is not written in the memory device 150 and is managed only within the memory 144 at step 60.

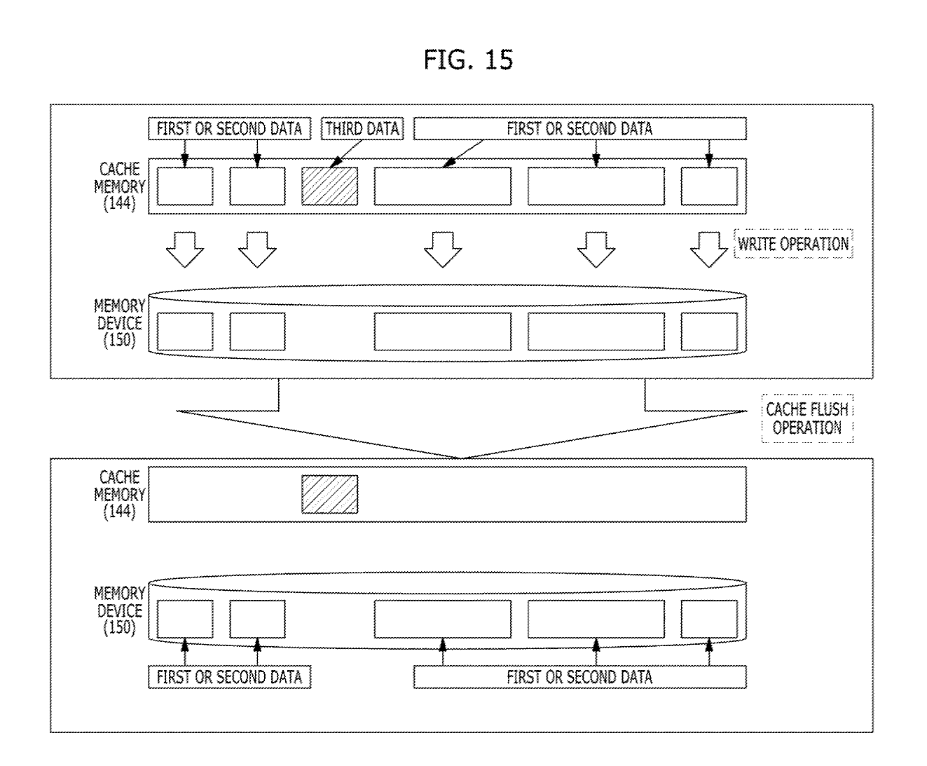

FIG. 15 is a diagram illustrating a cache flush operation of the memory system 110 in accordance with an embodiment of the present invention.

More specifically, as described above with reference to FIGS. 12A and 12B, FIGS. 13A and 13B, and FIG. 14, the data DATA<1:8> or DATA<1:11> provided from the host 102 is classified into the first to third classification data. The data DATA<1:8> or DATA<1:11> provided from the host 102 and classified into the first to third classification data is stored in the memory 144 regardless of the type. The operation speed of the memory system 110 can be increased because the memory 144 operates between the host 102 and the memory device 150 with relatively higher speed than the memory device 150.

The first to third classification data stored in the memory 144 is written into the memory device 150 during the write operation. In this case, the first and the second classification data stored in both the memory device 150 and the memory 144 may be selectively deleted or may not be selectively deleted from the memory 144 depending on the importance of corresponding data or the operation of the memory system. In contrast, the third classification data is not stored in the memory device 150 but remains in the memory 144 even during the write operation, and always remains in the memory 144 regardless of the operation of the memory system.

In particular, as shown in FIG. 15, the third classification data is not deleted even during the cache flush operation in response to the cache flush command for deleting all the data stored in the memory 144.

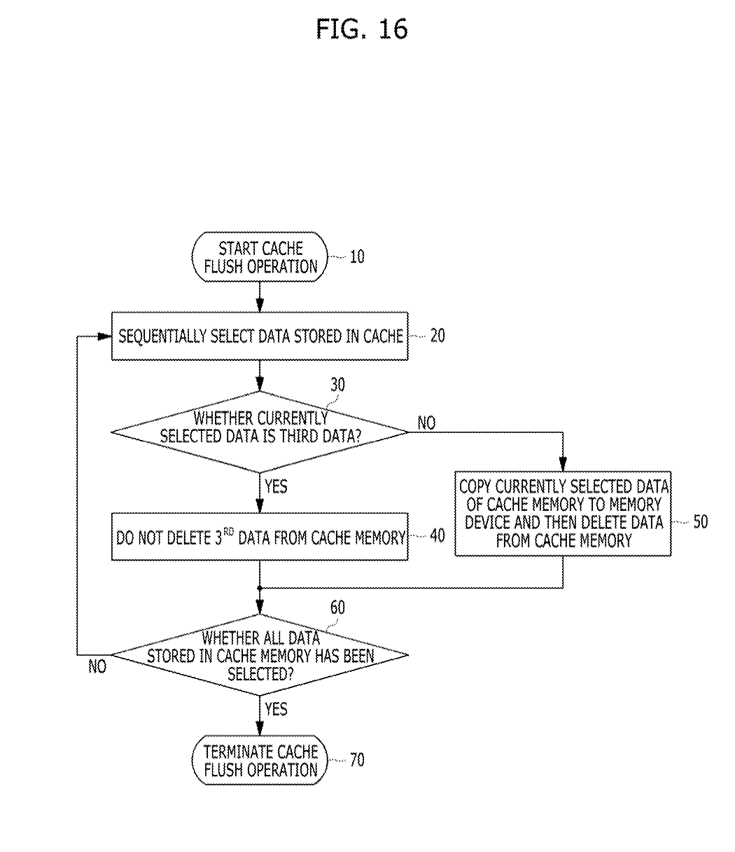

FIG. 16 is a flowchart illustrating the cache flush operation of FIG. 15 performed in the memory system in accordance with an embodiment of the present invention.

The cache flush operation is started at step 10.

The controller 130 selects data stored in the memory 144 in a predetermined order at step 20.

The controller 130 determines whether the selected data is the third classification data at step 30. When the selected data is the third classification data (“YES” at step 30), the selected data is not deleted from the memory 144 at step 40. When the selected data is not the third classification data (“NO” at step 40), the selected data is written to the memory device 150 and deleted from the memory 144 at step 50.

Next, the controller 130 determines whether all the data stored in the memory 144 has been selected at step 60. When all the data stored in the memory 144 has been selected (“YES” at step 60), the controller 130 determines that the cache flush operation has been completed and terminates the cache flush operation at step 70. When all the data stored in the memory 144 has not been selected (“NO” at step 60), the controller 130 repeats steps 20 to 60 until all the data stored in the memory 144 is selected.

As described above, when a cache flush operation is performed, the memory system in accordance with an embodiment of the present invention determines whether each of all the data stored in the memory 144 is the third classification data and deletes the first and the second classification data without deleting the third classification data based on a result of the determination.

In accordance with an embodiment of the present invention, the type of data provided by the host is classified, and specific data is managed only in the cache memory depending on the type of data. Accordingly, specific data that requires relatively frequent input/output operations can be managed more effectively.

Although various embodiments have been described for illustrative purposes, it will be apparent to those skilled in the art that various changes and modifications may be made without departing from the spirit and scope of the invention as defined in the following claims.

What is claimed is:

1. A memory system, comprising:
a memory device;
a memory suitable for temporarily storing data transferred between a host and the memory device; and
a controller suitable for classifying data provided from the host into first classification data of relatively great size based on a reference size and second classification data of relatively small size based on the reference size, classifying one or more of the second classification data, which is repeatedly provided more than a threshold value of repetition, as third classification data, and managing the third classification data only in the memory.

2. The memory system of claim 1, wherein when the first classification data is repeatedly provided more than two times, the controller classifies the second classification data that is provided between the repeatedly provided first classification data and that repeatedly has a same logical address more than the threshold value of repetition as the third classification data.

3. The memory system of claim 2, wherein the controller is suitable for:
accumulating the logical addresses of the second classification data in a logical address storage space whenever the second classification data is provided; and
classifying one or more of the second classification data having the accumulated number of the logical address greater than the threshold value of repetition as the third classification data.

4. The memory system of claim 2, wherein the controller is suitable for classifying a bulk of data having a size greater than a first reference size and random logical address, or a series of data, each of which has a size smaller than the first reference size and greater than a second reference size, and which have continuous logical addresses, as the first classification data.

5. The memory system of claim 1, wherein the controller is suitable for:
storing the first and the second classification data in the memory when a write operation is performed,
writing the first and the second classification data of the memory into the memory device, and
keeping the third classification data in the memory.

6. The memory system of claim 5, wherein during a cache flush operation, the controller deletes the first and the second classification data from the memory while keeping the third classification data in the memory.

7. The memory system of claim 1, wherein:
the first and the second classification data comprises user data, and
the third classification data comprises metadata.

8. An operating method of a memory system comprising a memory device and a memory, the operating method comprises:
classifying data provided from the host into first classification data of relatively great size based on a reference size and second classification data of relatively small size based on the reference size;
classifying one or more of the second classification data, which is repeatedly provided more than a threshold value of repetition, as third classification data; and
managing the third classification data only in the memory.

9. The operating method of claim 8, wherein when the first classification data is repeatedly provided more than two times, the classifying the second classification data as the third classification data includes classifying the second classification data that is provided between the repeatedly provided first classification data and that repeatedly has a same logical address more than the threshold value of repetition as the third classification data.

10. The operating method of claim 9, wherein the classifying the second classification data as the third classification data comprises:
accumulating the logical addresses of the second classification data in a logical address storage space whenever the second classification data is provided; and
classifying one or more of the second classification data having the accumulated number of the logical address greater than the threshold value of repetition as the third classification data.

11. The operating method of claim 9, wherein the classifying of the data into the first and second classification data comprises classifying a bulk of data having a size greater than a first reference size and random logical address, or a series of data, each of which has a size smaller than the first reference size and greater than a second reference size, and which have continuous logical addresses, as the first classification data.

12. The operating method of claim 8, wherein the managing of the third classification data comprises:
storing the first and the second classification data in the memory when a write operation is performed;
writing the first and the second classification data of the memory into the memory device; and
keeping the third classification data in the memory.

13. The operating method of claim 12, wherein the managing of the third classification data comprises deleting the first and the second classification data from the memory while keeping the third classification data in the memory during a cache flush operation.

14. The operating method of claim 8, wherein:
the first and the second classification data comprises user data, and
the third classification data comprises metadata.
